(19) United States
(12) Patent Application Publication
(10) Pub. No.: US 2002/0159749 A1
(43) Pub. Date: Oct. 31, 2002

(54) Method and apparatus for motion estimation in image-sequences with efficient content-based smoothness constraint

(75) Inventor: Alexander Kobilansky, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/809,361

(22) Filed: Mar. 15, 2001

(51) Int. Cl. H04N 7/18; H04N 9/00; H04N 11/00

(52) U.S. Cl. 386/1; 348/154; 348/155

(57) ABSTRACT

A motion estimation technique incorporates a smoothness constraint which is strengthened for reference regions characterized by an image property that is close to that of neighboring regions. Preferably, the image property should be a normalized figure to account for inherent variability distributed over the region.

### BACKGROUND OF THE INVENTION

1. Field of the Invention

The invention relates to the image processing of motion picture and video sequences for various purposes including improving image quality and compression of image sequence (e.g., video) data signals.

2. Background

The invention provides enhancements to the process of estimating motion in image-sequences such as those that originate from motion pictures or television video. The invention is applicable to any source of image-sequences.

Motion in image-sequences is analyzed for various reasons. For example, it is a component of various methods for image-sequence (e.g., video) quality enhancement, generation of interpolated frames between the frames of an image-sequence, image-sequence compression, removal of noise present in image-sequences, and more. For example, motion estimation can be used to improve images because it allows images of different frames to be averaged. Averaging reduces noise because images of the same subject taken over and over, if averaged, produces a higher quality representation of the subject than any of the original images. In image-sequences, such as video, successive frames are often very similar except for the fact that parts of the image are displaced relative to their positions in other frames. For example, a truck drives by and each frame shows the truck in a slightly different position. Even though the frames are different, by compensating for the motion it is possible to average the displaced parts of their images.

Generating frames between existing frames, for example for frame rate conversion, obviously requires motion estimation, since, if something in an image moves from one position to another in successive frames, it should only move a fraction of the same distance and direction in the intervening frames.

Motion estimation may be applied to portions of the image frames making up an image-sequence. That is, the frames may be cut up into the same number and shape of parts, say squares, and the movement of each part detected from frame to frame. In the truck example above, the portion might be a square block from the side of the truck with some parts of the owner's logo. The motion estimation process, running on a computer, searches in a neighborhood of the part of the next (or previous) frame for a block that is closest to it (i.e., contains the same parts of the logo as the previous or successive frame). Assuming the truck was moving gradually and not too fast, the corresponding block in the second frame would be expected to be found in the neighborhood of the same location as the block in the first frame. In the illustrative example above the blocks are chosen to be square, but they could have any shapes, which could also be variegated.

If one considers the source of motion in image-sequences, for example the physical movement of various subjects relative to a camera (or its equivalent, for example in animations), it is obvious that motion in image-sequences can be described as the movement of various blobs of color and light on the screen. Further consideration should make it clear that the whole assumption that blobs simply move around is imperfect because they also rotate, shrink (e.g., when an object is gradually hidden), disappear (e.g., scene breaks), etc., but it is not necessary to consider where motion estimation fails for purposes of understanding the invention. If the motion estimation fails for certain parts of an image or certain image-sequences, the motion information may simply be ignored and not used for its intended purposes. For example, if the goal is quality enhancement, the relevant portions may be skipped over and the images left untreated or treated in some way that does not require motion estimation.

As the various blobs in an image-sequence may have different shapes and may move in different directions and speeds, a square block that contains a portion of different blobs that are moving differently is not susceptible to straightforward motion interpretation. Motion estimation is unambiguously successful when a block in a first frame substantially matches (looks like) a block in a second image-sequence. The process used to discover how a block has moved is responsive to whether a block in the second image frame matches the block in the first image. If there isn't a good match, then the motion estimation may be invalid. The estimation of how well blocks in adjacent images match is called “correspondence” and the requirement that the match reach some level of goodness is called the “correspondence constraint.”

There is another constraint involved in estimating motion of blocks. This constraint stems from the fact that it is believed that the motions of the blobs determined purely by block matching are not as smooth as they should be. Thus, if only block-matching were used to predict motion, the resulting motion prediction would be overly responsive to noise, changes in illumination, complex motion of numerous small objects like tree foliage, etc. and therefore fail to reflect what would normally be considered the natural motion desired. To improve the motion estimations for the blocks, assuming typical moving blobs are bigger than the block size, one may look to adjacent blocks under the assumption that the blocks of which moving blobs are made move in unison. Thus, in estimating motion, the displacements of neighboring blocks are taken into account so that neighboring blocks tend to move in unison.

The assumption that neighboring blocks move in unison is called a “smoothness constraint.” To enforce the smoothness constraint, the process of calculation of displacement estimates is implemented such that displacement estimates are urged toward the same values for neighboring regions. To accomplish this, one may think of calculating a single “energy” value that depends on two factors: (a) how well all the displaced regions match corresponding regions on the second frame (correspondence) and (b) how well the region displacements match those of their respective neighbors (smoothness). The energy value would be large when either the correspondence or smoothness constraint is poorly satisfied and small when they are well satisfied. The optimization amounts to calculating all the displacement vectors such as to minimize this combined energy value. This optimization process can be accomplished by various computational techniques that are known in the art.

It should be obvious that the smoothness constraint is not applicable for all blocks because, just as blocks belonging to differently-moving blobs do not fit the correspondence constraint, neighboring blocks belonging to differently-moving blobs do not fit the smoothness constraint. In the prior art, there are various ways in which the smoothness constraint can be relaxed, or permitted to be broken, to allow for situations where neighboring blocks belong to different blobs. For example, the constraint between blocks may be broken when the blocks are apparently from different blobs. This can be done by analyzing the image content to identify features that indicate when neighboring blocks belong to different blobs. One image processing technique detects edges (abrupt changes in color and/or luminance that lie along a line) under the assumption that the edge defines a boundary between different blobs. When edges are found between blocks, the smoothness constraint between those blocks is relaxed, or allowed to be broken. The assumption underlying the edge-detection approach is not always valid, but it can lead to improvements.

There are other quite sophisticated computational tricks for adjusting the smoothness constraint so that it is enforced only where applicable. The more sophisticated of these techniques may involve a process called segmentation, which identifies separate blobs. These techniques in turn use motion estimation, so the process is iterative and, therefore, takes a great deal of time on a computer. As a result, there is a need in the art for techniques for modifying the smoothness constraint that are not computationally intensive and produce good results.

### SUMMARY OF PRIOR ART

To put the above discussion in more precise technical terms, the goal of 2D motion estimation is to determine how different parts of each image in an image-sequence move from frame to frame. The result is usually described by an array of two-dimensional displacement vectors d(r), indicating how a region (e.g., block) r in a current image frame has moved to r+d(r) in a following or previous image frame. For purposes of this discussion, a current image frame may be referred to as a “reference frame” and a temporally neighboring frame as a “target frame.”

Displacement vectors are defined in sites r∈ [symbol] , the finite set [symbol] is a subset of all possible region positions. Practical methods for motion estimation are based on the combination of the two constraints: The correspondence constraint and the smoothness constraint. The correspondence constraint insures that a region r of a reference image is reasonably well mapped to a region r+d(r) in a target frame. In other words, region r+d(r) in target frame should have image properties like texture, luminance, and/or color close to those of the region r in the reference frame.

The details of how the correspondence constraint is designed and enforced are not relevant to an understanding of the invention and will not be described further.

The smoothness constraint is based on the assumption that neighboring parts of an image region r frequently move together; that is, they are all described by similar motion vectors d(r). A simple form of smoothness constraint may be described by an energy function, which does not depend explicitly on image content:

Eₛ=Σ_{r0∈} [symbol] Σ_{r1∈ (r0)} [symbol]fₛ(|d(r0)−d(r1)|), (1)

where, [symbol] (r) is the spatial neighborhood of site r, and function fₛ is a suitable (preferably, monotonic) function that approaches a minimum when its argument decreases to zero. To implement the smoothness constraint, the values for the displacement vectors d(r), r∈ [symbol] , that correspond to the lowest possible value of Eₛ are found by any suitable computational technique.

A disadvantage of the above smoothness constraint is that it encourages smoothness of displacement vectors that may belong to different blobs undergoing different motions. The various prior art methods developed to break the smoothness constraint between objects are variously based on adding some image-content dependent factors to the function f_{S}. To formulate a good smoothness constraint, the image needs to be segmented. Robust image segmentation should, in turn, use motion estimation. This can lead to complex computation-intensive recursive processes. Simpler methods break image constraint on “edges”, defined as connected sites of local maxima of the image gradient. This approach requires choosing threshold values that differ for different image-sequences.

The invention will be described in connection with certain preferred embodiments, so that it may be more fully understood. The particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description making apparent to those skilled in the art how the several forms of the invention may be embodied in practice.

### SUMMARY OF THE INVENTION

Briefly, motion estimation employs a smoothness constraint which is strengthened for reference regions characterized by an image property that is close to that of neighboring regions. Preferably, the image property should be a normalized figure to account for inherent variability distributed over the region.

In prior art methods of smoothing the displacement vector field, the smoothness constraint is relaxed, or allowed to be broken, based on image content. The proposed methods, however, have proven very complex. According to the invention, a new form of smoothness constraint, which has low computational complexity is employed. To describe the method simply, a value that defines how well all the displacement vectors satisfy both the smoothness constraint and the correspondence constraint takes into account an average property, such as color, of neighboring regions. The displacements that are calculated for neighboring regions differing greatly in the average property from a given region contribute little to the calculated smoothness quality of the displacement vector field estimate. In contrast, displacements that are calculated for neighboring regions that differ little in the average image property, from the given region, contribute greatly to the calculated smoothness quality of the displacement field estimate.

### DETAILED DESCRIPTION OF THE PREFERRED EMBODIMENTS

According to an embodiment, the image property used for the above method is an average color of the region. The problem of calculating a field of displacement vectors that satisfies both correspondence and smoothness constraints may be expressed in the following way: Find a set of displacement vectors d(r) that minimizes a combination (e.g. a linear combination) of correspondence energy E_{c} and smoothness energy Eₛ:

min({d(r)}, r∈ [symbol] )(E_{c}+p* Eₛ), (2)

where p is a heuristic that controls the strength of the smoothness constraint. Equation (2) is essentially equivalent to ones described in B. K. P. Horn and B. G. Schunck, “Determining optical flow”, Artificial Intelligence, Vol. 17, pp. 185-203, 1981, and in A. Murat Tekalp, “Digital Video Processing”, Prentice-Hall, 1995. ISBN 0131900757. Equation (2) is presented here only to explain the relation between correspondence and smoothness constraints and their role in motion estimation. In general it is not necessary to explicitly use two energy terms. For example, in Sergei V. Fogel, “The Estimation of Velocity Vector Fields from Time-Varying Image-sequences”, CVGIP: Image Understanding, Vol. 53, pp. 253-287, 1991, expression (2) was not used, but the author operated directly with constraints that logically contained correspondence and smoothness components. Equation (2) and its alternatives may be solved using variety of approaches, for example, by an iterative procedure, minimizing total energy (2) for one vector d(r) at a time, or by forming a large system of nonlinear equations that includes the whole array of displacement vectors from the reference image.

In an embodiment conforming to the form of equation (2), the smoothness component of an energy equation is as follows:

$$\begin{matrix}{E}_{s} = \sum r0 ∈ ℜ \sum r1 ∈ 𝒩 ( r0 ) {f}_{s} ( c ( r0 ) , c ( r1 ) , \\ v ( r0 ) , v ( r1 ) , d ( r0 ) , d ( r1 ) ) ,\end{matrix} \qquad ( 3 )$$

where c(r) and v(r) are functions that represent color and color variation, respectively. The c(r) and v(r) functions are vector-valued functions having as many components as there are color channels in the image-sequence. The c(r) function represents average color pixel value of the reference image in a neighborhood of a site r; v(r) represents variation of color in a neighborhood of r; and f (c0, c1, v0, v1, d0, d1) (using a shorthand notation, c0 representing c(r0), c1 representing c(r1), and so on) is a scalar function with the following properties:

As c0 gets closer to c1, the closeness being measured by corresponding components of v0, v1, the sensitivity of fₛ to small changes in d0 and d1 increases toward a maximum.

As the difference between c0 and c1 significantly exceeds corresponding components of both v0 and v1, fₛ becomes less sensitive to changes in d0 and d1.

To implement the method, the single energy function (2) that includes both Eₛ and E_{c} is minimized. The total energy includes inputs from all reference region displacements d0 (which is the outer sum in equation (3) and for every reference region with displacement d0, for all neighboring regions d1 (which is the inner sum in equation 3). Again, although the smoothness energy is referred to apart from the correspondence energy, the two need not be separable components of a function to be minimized in calculating the displacement vector field. In this example embodiment, however, the correspondence energy and smoothness energy form a linear combination.

There are many ways to satisfy the above functional requirements. One example is a preferred expression for smoothness energy described below. Let each image in an image-sequence be defined on nₓ*n_{y} rectangular grid and have n_{c} channels. Images are divided into n_{b}*n_{b} square blocks B(r), where r points to the center of the block. One displacement vector d(r) is calculated for each block. The resulting set of displacement vectors d(r) form a rectangular grid

[symbol]

Displacement vectors are calculated by minimizing a total energy expressed as a sum of correspondence energy E_{c} and smoothness energy Eₛ as in equation (2). Correspondence energy E_{c} may be calculated as a sum of terms that describe how well pixels in block B(r) at r in the reference image correspond to a group of pixels around r+d(r) in the target image. The total energy is calculated over all r∈ [symbol] . The exact form of the correspondence energy component is not essential to the practice of the present embodiment of the invention where the focus is on the contribution of smoothness constraint. Smoothness energy Eₛ is calculated using equation (3), where [symbol] (r) is a set of at most eight blocks (“at most” for purposes of this illustrative example, only) that are the nearest spatial neighbors of block r. Functions c(r) and v(r) are vector-valued n_{c}-component functions, each component k=1, . . . n_{c} calculated from reference image data i(x) within the block B(r):

cₖ(r)=(Σ_{x∈B(r)}iₖ(x))/n_{b}², (4)

vₖ(r)=sqrt((Σ_{x∈B(r)}(iₖ(x)−cₖ(r))²)/(n_{b}²−1)+σₖ²), (5)

where σₖ represents a background variation of the image data iₖ(x) resulting from noise or grain.

Function fₛ in (3) then has the following form:

$${f}_{s} ( c0 , c1 , v0 , v1 , d0 , d1 ) = exp ( - {\sum }_{k} {( max ( 0 , {( {c0}_{k} - {c1}_{k} )}^{2} / ( {v0}_{k}^{2} + {v1}_{k}^{2} ) - 1 ) )}^{2} / 5 ) * {\prod }_{k} {( 1 - ( {v0}_{k}^{2} - {v1}_{k}^{2} ) / ( {v0}_{k}^{2} + {v1}_{k}^{2} ) )}^{2} * {\prod }_{k} {( {d0}_{k} - {d1}_{k} )}^{2} \qquad ( 6 )$$

Expression (6) satisfies both the requirements for fₛ, as described above. An important feature of the smoothness constraint function is that smoothness is encouraged only between blocks that have similar color patterns.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A method of calculating displacement vectors corresponding to respective reference image regions of a reference frame of an image-sequence, comprising the steps of:
optimizing a function whose value depends on a closeness in value of each of said reference image region displacement vectors to values of adjacent ones of said reference image region displacement vectors;
said function being more sensitive to said closeness in value when an image property of said each of said reference region displacement vectors is close in value to said adjacent ones and less sensitive to said closeness in value when an image property of said each of said reference region displacement vectors is close in value to said adjacent ones.

2. A method as in claim 1, wherein said function value depends on a similarity of said reference regions to respective target regions.

3. A method as in claim 1, wherein said image property includes color.

4. A method as in claim 1, wherein said image property includes an average color.

5. A method as in claim 4, wherein said function value depends on a similarity of said reference regions to respective target regions.

6. A method as in claim 1, wherein said image property includes a color normalized by an estimate of color variation characteristic of said each of said reference regions and said adjacent ones.

7. A method as in claim 1, wherein said function is a combination of a function whose value depends on a similarity of said reference regions to respective target regions and a function whose value depends on a closeness in value of each of said reference image region displacement vectors to values of adjacent ones of said reference image region displacement vectors.

8. A method as in claim 7, wherein said image property includes color.

9. A method as in claim 7, wherein said image property includes an average color.

10. A method as in claim 7, wherein said image property includes a color normalized by an estimate of color variation characteristic of said each of said reference regions and said adjacent ones.

11. A method for calculating a smooth motion vector field of an image sequence, comprising the steps of:
calculating displacement vectors for each of a plurality of image segments responsively to displacement vectors of a spatially-neighboring set of said plurality of image segments;
said step of calculating being responsive to an image property of each of said neighboring set of image segments.

12. A method as in claim 11, wherein said image property is responsive to a variation of said image property over at least one of said each of a plurality and said each of said neighboring set of image segments.

13. A method as in claim 11, wherein said image property includes color.

14. A method as in claim 13, wherein said image property includes an average color of said reference regions.

15. A method as in claim 11, wherein said image property includes luminosity.

16. A method as in claim 15, wherein said image property includes a color.

17. A medium holding program data, said program data defining a method for calculating a motion vector field of a image sequence stream, comprising the steps of:
optimizing a function whose value depends on a closeness in value of each of said reference image region displacement vectors to values of adjacent ones of said reference image region displacement vectors;
said function being more sensitive to said closeness in value when an image property of said each of said reference region displacement vectors is close in value to said adjacent ones and less sensitive to said closeness in value when an image property of said each of said reference region displacement vectors is close in value to said adjacent ones.

18. A method as in claim 17 wherein said function value depends on a similarity of said reference regions to respective target regions.

19. A method as in claim 17 wherein said image property includes color.

20. A method as in claim 17 wherein said image property includes an average color.

21. A method as in claim 20, wherein said function value depends on a similarity of said reference regions to respective target regions.

22. A method as in claim 17, wherein said image property includes a color normalized by an estimate of color variation characteristic of said each of said reference regions and said adjacent ones.

23. A method as in claim 17, wherein said function is a combination of a function whose value depends on a similarity of said reference regions to respective target regions and a function whose value depends on a closeness in value of each of said reference image region displacement vectors to values of adjacent ones of said reference image region displacement vectors.

24. A method as in claim 23, wherein said image property includes color.

25. A method as in claim 23, wherein said image property includes an average color.

26. A method as in claim 23, wherein said image property includes a color normalized by an estimate of color variation characteristic of said each of said reference regions and said adjacent ones.
